(19) United States
(12) Patent Application Publication
(10) Pub. No.: US 2009/0072549 A1
(43) Pub. Date: Mar. 19, 2009

(54) Panic Exit and Enclosure Gate Method

(76) Inventors: Michael Jeremy Garlington, Farmington, NM (US); Timothy Ray Jantz, Durango, CO (US)

Correspondence Address: THE LUTHER LAW FIRM, PLC, 10575 N 114TH STREET, SUITE 103, SCOTTSDALE, AZ, 85259, US

(21) Appl. No.: 12/018,431

(22) Filed: Jan. 23, 2008

Related U.S. Application Data
(60) Provisional application No. 60/973,160, filed on Sep. 17, 2007.

(51) Int. Cl. E05C 19/00; E04H 17/00

(52) U.S. Cl. 292/122; 292/346; 256/1

(57) ABSTRACT

A method of gating a fence starts with providing an exit that has spaced-apart first and second enclosure portions joined by upper and lower cross-members and at least one anchor joined to at least one of said enclosure portions; a mostly solid door between said enclosure portions and openable, said door and said enclosure portions having inward-facing surfaces; a latch coupling said door to one enclosure portion, said latch securing said door closed, said latch only operable from said inward-facing surface; and a guard attached to one of said enclosure portions and projecting inwardly proximate said latch. The next steps are digging holes for the enclosure portions and at least one anchor sufficiently deep to permit the lower cross-member to sit in the ground; placing the exit; pouring concrete up to about the ground surface; and attaching the fence to the enclosure portions.

### RELATED APPLICATIONS

This application claims the benefit of earlier-filed U.S. Provisional Patent Application No. 60/973,160, filed Sep. 17, 2007.

### TECHNICAL FIELD

The present invention relates to safety exit gates designed to thwart entry by unwanted visitors and especially to such gates affording quick escape from fire or the like.

### BACKGROUND

Oil and gas sites need to have exit-only doors for employees to race out if there is an explosion, spill or other serious problem. Generally, such exit-only gates are constructed on-site. The fence installer digs post holes for supports on either side of the gate. The supports are set in place and concrete is poured around the supports up to the ground level. Then connectors are welded to the supports to provide hinges for the door to swing open. For panic exits, the side of the gate facing the work area is equipped with a horizontal bar that immediately opens the gate when depressed.

Current gates are deficient in several ways. Problems include lack of safety and difficulties surrounding the process of installing the gate. Current gates allow a determined person—terrorist or teenager—to enter the work area. Even though the work area is surrounded with a fence topped with barbed wire, terrorists could defeat current gates with little difficulty and cause a dramatic explosion. Moreover, youths are drawn to the pumps and are able to enter the area, often at the exit-only gate. Even though the gate has a release only on the inside, determined youths with smaller limbs can get around the usual preventative measures and open the exit-only gate. Children like to ride on the moving pump jack and will climb onto it. However, because the pump jack is slippery with oil, they fall off and onto the underlying counterweight. If they do not immediately hop off the counterweight, they can be crushed between the moving pump jack and the counterweight. In the San Juan Basin alone, seven children have been killed in the oil fields in the last five years. Countless others have entered the forbidden enclosures.

In spite of the identified risks posed by terrorist and to neighboring children, no progress has been made in improving exit-only gates and deterring unwanted access. One of the reasons is the economics of the situation. Because current technology requires welding near oil or gas, the company desiring the gate must first apply for and negotiate to obtain a “hot-work” permit. In that, the company experts describe the steps to minimize explosion. Then they must assemble a team to oversee gate installation, including inspectors and assorted company supervisors. The company also must stop all oil/gas pumping activity to lower the amount of oil or gas in the air and thereby decrease the possibility of explosion. The team may need to sweep the area with a sensor to assure a low level of volatile gases.

Only when the site is established as safe can the fence installer enter and install the gate. Therefore, the current practice is very time-consuming, with delays for obtaining a “hot-work” permit and for assembling the team to oversee this potentially disastrous activity. The current practice is very expensive, with specialized employees necessary to prepare the permit application and to supervise the gate site. Not to be ignored is the cost of closing down the work site: stopping oil pumping for several hours or a day can cost $10,000 to $100,000. Little money is left over for the actual installation of the gate, so that activity is usually assigned to the lowest bidder, using current methods and cheap materials.

In contrast, there have been recent developments in child-proofing fences and gates, but most of these are designed to increase the difficulty of manipulating the gate and latches. For example, U.S. Pat. No. 5,217,265 features a gate latch with two control members which are separated by a distance greater than that which can be effectively spanned by a preschool child. The control members must be operated first in a sequence and then simultaneously to operate the latch release mechanism. Such controls would slow employee exit and would not prevent terrorist access. Clearly such mechanisms are incompatible with panic exiting from a gas or oil disaster.

What is needed is a solution to the current problems of access by terrorists and children, possibility of explosion during installation, and expensive and time-consuming delays due to permitting and activities by highly trained employees.

### SUMMARY OF THE INVENTION

An exemplary embodiment of an exit in accordance with the present invention includes spaced apart first and second enclosure portions; a mostly solid door disposed between the enclosure portions, the door being movable between a closed position and an open position relative to the enclosure portions, the door and the enclosure portions having inward-facing surfaces; a latch operatively coupling the door to at least one of the enclosure portions, the latch being operable to secure the door in the closed position, the latch being operable from proximate the inward-facing surface to release the door to be moved to the open position; and a guard attached to one of the enclosure portions and projecting inwardly proximate the latch. The guard blocks most attempts by a person standing outside the gate to manipulate the latch with a tool, a finger, or perhaps forcing a hand or arm through the gate or fence and reaching toward the latch. Being installed on an immobile part of the gate, the guard is stationary in a relatively safe, familiar, fixed location and does not move with the door.

Another exemplary embodiment of an exit in accordance with the present invention has a penetration-defeating barrier disposed on the door proximate the latch. This reinforces the part of the door nearest the latch and, especially where the door is not solid, helps exclude fingers and tools from the part of the door nearest the latch.

In another exemplary embodiment, the enclosure portions are joined together, preferably by cross-members welded to them above and below the level of the door, allowing the combination to be delivered with the door already hung on the first enclosure portion and the latch correctly approximated to the second enclosure portion.

In another exemplary embodiment, at least one anchor is attached to at least one of the enclosure portions. Preferably, each of them has an anchor attached. Anchors are used to immobilize the enclosure portions when the anchors are buried or in concrete.

In another exemplary embodiment, at least one of the enclosure portions includes a post. Round or rectangular tubular galvanized steel of the type found in cyclone fencing and other outdoor enclosures works well and is easily welded or bolted.

In another exemplary embodiment, the door is movable, outward-only, to the open position. In certain embodiments of the present invention, the guard angles or curves distally toward the door and might interfere with the door were the door to open inwardly. In one such exemplary embodiment, the guard projects inwardly and at an angle toward the door and partially covers the latch proximate the inward-facing surface of the door, the better to frustrate attempts to reach the latch from outside the gate and fence. In another such exemplary embodiment, the guard projects inwardly and curves distally toward the door and partially covers the latch proximate the inward facing surface of the door.

In another exemplary embodiment, the latch includes a push-bar opening mechanism very well suited to the needs of a person fleeing from fire or other danger. Also in accordance with the present invention, an exemplary embodiment of an exit door closure for securing a mostly solid door, where the door has an inward-facing surface and an opposite, outward-facing surface, relative to an adjacent enclosure portion, and where the enclosure portion also has an inward-facing surface and an opposite, outward-facing surface, the claimed exit closure, includes a latch operatively coupling the door to enclosure portion, the latch being operable to secure the door closed relative to the enclosure portion, the latch being operable from proximate the inward-facing surface of the door to release the door to open relative to the enclosure portion; and a guard projecting from the inward-facing surface of the enclosure portion proximate the latch. This combination of latch and guard are installed where an existing combination of door and enclosure portions is to be preserved, but security is to be upgraded.

Also in accordance with the present invention, an exemplary embodiment of an exit door closure guard, for thwarting circumvention of a latch closing an exit door relative to an enclosure portion, where the door has an inward-facing surface and an opposite, outward-facing surface, relative to an adjacent enclosure portion, and where the enclosure portion also has an inward-facing surface and an opposite, outward-facing surface, includes a guard projecting from the inward-facing surface of the enclosure portion proximate the latch. This guard is installed where an existing combination of enclosure portions, door and latch is to be preserved, but security is to be upgraded.

Also in accordance with the present invention, an exemplary method of gating a fence has the steps of integrating spaced-apart first and second enclosure portions with the fence; disposing a mostly solid door between the enclosure portions, the door being movable between a closed position and an open position relative to the enclosure portions, the door and the enclosure portions having inward-facing surfaces; providing a latch operatively coupling the door to at least one of the enclosure portions, the latch being operable to secure the door in the closed position, the latch being operable from proximate the inward-facing surface to release the door to be moved to the open position; and affixing a guard to one of the enclosure portions, the guard projecting inwardly proximate the latch. This method provides or upgrades gate security by replacing the existing enclosure portions, door and latch with the combination in accordance with the present invention.

In another exemplary method in accordance with the present invention, the step of joining the enclosure portions together is carried out before the step of integrating them with the fence. The enclosure portions, preferably with the door hung and the latch correctly approximated, are delivered to the site of installation as a unit.

Another exemplary method further includes a step of joining at least one anchor to at least one of the enclosure portions, preferably before integrating them with a fence. This provides an enclosure portion which is ready to be immobilized by burial or setting in concrete.

Another exemplary method includes the steps of joining the enclosure portions together. Performing all these steps before installation—and even before delivery—reduces the need for labor and tools at the site of installation.

This exemplary method of gating a fence has a first step of providing an exit with spaced-apart first and second enclosure portions joined by an upper cross-member and a lower cross-member and at least one anchor joined to at least one of said enclosure portions; a mostly solid door disposed between said enclosure portions, said door being movable between a closed position and an open position relative to said enclosure portions, said door and said enclosure portions having inward-facing surfaces; a latch operatively coupling said door to one of said enclosure portions, said latch being operable to secure said door in said closed position, said latch being operable from said inward-facing surface to release said door to be moved to said open position; and a guard attached to one of said enclosure portions and projecting inwardly proximate said latch. The other steps include digging holes for the enclosure portions and at least one anchor sufficiently deep to permit the lower cross-member to sit in the ground; placing the exit; pouring concrete up to about the ground surface; and attaching the fence to the enclosure portions.

### BRIEF DESCRIPTION OF THE DRAWINGS

For a further understanding of the objects and advantages of the present invention, reference should be had to the following detailed description, taken in conjunction with the accompanying drawing, in which like parts are given like reference numbers and wherein:

FIGS. 1 and 2 are perspective views of a prior art structure;

FIG. 3 is an inside elevational view of an exit in accordance with the present invention;

FIG. 4 is a top view thereof;

FIG. 5 is a top view thereof;

FIG. 6 is an inside perspective view thereof;

FIGS. 7 and 8 are top views of alternative embodiments thereof; and

FIG. 9 is an outside elevational view thereof.

### DETAILED DESCRIPTION OF THE PREFERRED EMBODIMENTS

There are significant problems and delays at oil and gas sites in installing the current style of panic-exit gates. Because of the current design, there are frequent reports of accidents and even deaths of children at oil and gas sites. Even worse, such sites could easily be entered by terrorists to create a large-scale incident. We have designed an innovative latched gate to solve these vexing safety problems. In an additional embodiment, we have made further improvements to not only increase safety but also avoid the risk of explosion during installation. Because of these additional improvements, companies can avoid welding and the attendant “hot-work” permitting process, closure of the work site and presence of additional personnel.

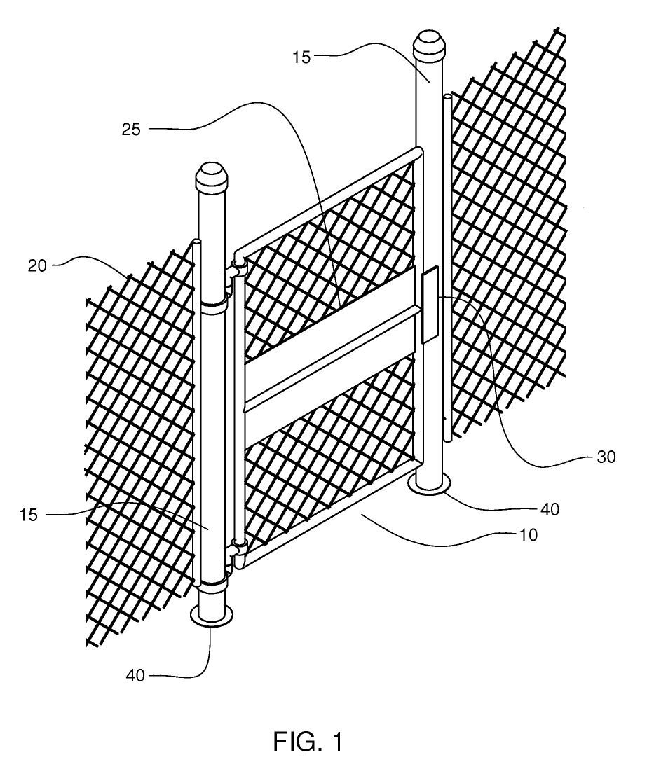

FIG. 1 shows an outside perspective view (from outside the work site) of current gate construction, which provides a light-weight chain-link gate 10, with light-weight supports 15 on either side which are welded to the chain-link fence 20. A horizontal plate 25 is positioned across the middle of the gate 10 to slow access to the latch (see FIG. 2). To the right of the gate 10 is a vertical plate 30, which is welded to the edge of the gate 10 to slow access to the underlying latch (not shown). For security, the gate supports 15 are set in concrete 40. However, the light weight metal used in the typical assembly can be pushed and pulled to permit the entry of a hand around or under the vertical plate 30. Also small hands can enter the chain links to the right of the vertical plate 30 to reach and open the latch. The inventor inserted a hand between the gate 10 and its lightweight supports 15 to open gate 10 and access the panic latch on the other side of the door (FIG. 2).

FIG. 2 is a closer view of the gate 10 from the inside, showing the side vertical plate 30 and the horizontal plate 25. Now the panic-exit device 35 is visible. It has a housing 42 which is attached to the gate 10. Inside the housing 42 is the depressible push bar 45. On the end of the panic-exit device 35 are latches 50 and 55. The lower larger latch 50 is actuated when push bar 45 is depressed. Latch 55 is part of the mechanism for use with an entry key and is unused and unneeded in this design.

In the following detailed description of preferred embodiments in accordance with the present invention, reference is made to the accompanying drawings that forma part hereof, and in which are shown by way of illustrating specific embodiments in which the invention may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of present inventions. The following detailed description, therefore, is not to be taken in a limiting sense, and the scope of various embodiments of the invention is defined only by the appended claims, along with the full range of equivalents to which such claims are entitled.

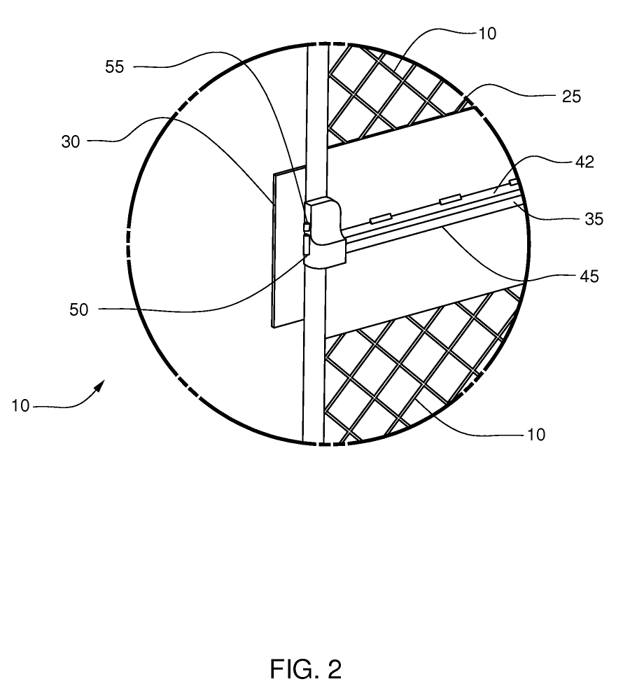

The invention will now be described with reference to FIG. 3, an inside elevational view of a preferred embodiment of an exit in accordance with the present invention, shown generally at 60, having a first enclosure portion 62, a second enclosure portion 64, a door 66, a latch 68, and a guard 70.

The first enclosure portion 62 and the second enclosure portion 64 are usually spaced-apart portions of an gate or fence such as may be built to secure an oil pump or any other hazardous area. While they are shown as square posts which are made of steel, aluminum or wood, they can also be spaced apart portions of any fence or wall, such as a stone or concrete wall, so long as they are robust enough to support a door 66 and meet the security requirements of the gate. In one embodiment, the enclosure portions are 3″ by 3″ square tubing with 3″×3″ caps. In the context of the present invention, the first and second enclosure portions 62 and 64 are preferably formed and placed precisely enough to assure close tolerance relative to a door 66 and should not permit a person easily to insert an arm into the area that is being enclosed. The door 66 is disposed between the first enclosure portion 62 and the second enclosure portion 64 and is hinged to the first enclosure portion 62. In one embodiment, the door is 18ga sheet metal (galvanized) and has side, bottom and top reinforcements of 2″ by 2″ square 16ga tubing. In this embodiment the door measures about 48″ by 66″ tall. The side posts extend above the door and support at least one row of barbwire (e.g., 2 pt barbwire) or razor wire.

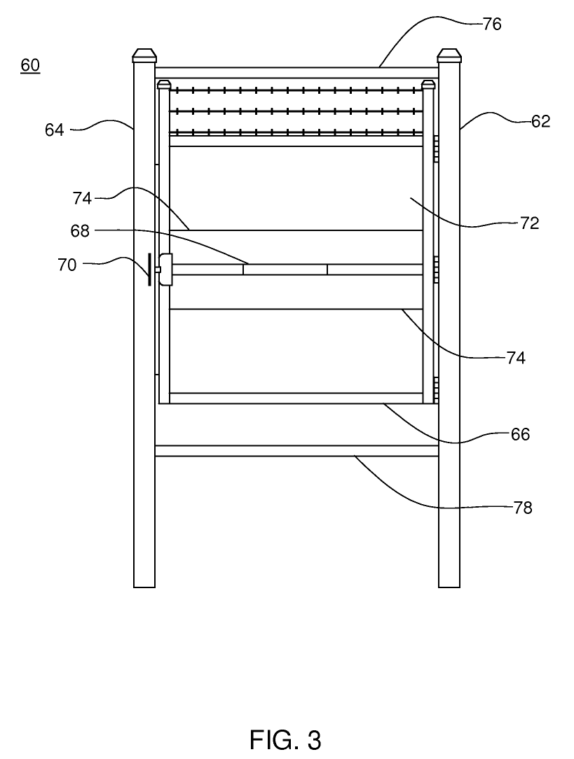

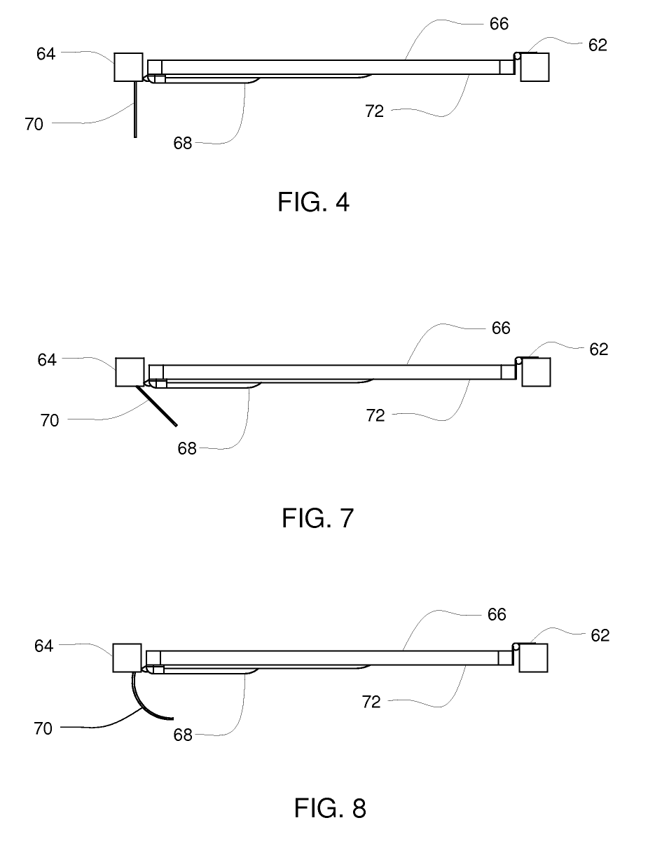

FIGS. 4 and 5 are top views of an exemplary embodiment of an exit in accordance with the present invention. The door 66 is movable between a closed position and an open position, here being shown hinged to the first enclosure portion 62 and openable in the outward direction relative to the second enclosure portion 64. The door 66 has an inward-facing surface 72, namely, the surface facing the interior of the area being enclosed. In one embodiment these hinges are 3″ door hinges disposed at the bottom, middle and top of the door.

The door 66 is hinged to the first enclosure portion 62 in any of a variety of ways: it may be balanced; alternatively, it may be biased closed, as, for example, by being mounted at an angle so as to be shut by gravity, or by being spring-hinged. The door 66 is preferably formed of a sturdy material (such as 18″ga galvanized sheet metal) without openings that would allow a person to insert an arm into the area that is being enclosed. Preferably, it is formed of heavy duty aluminum or, where the passage of wind or light is to be allowed, of a heavy duty steel mesh having openings too small for fingers or tools. For example, the door 66 has slits for passing of wind. Preferably, the door 66 is brightly colored or reflectively coated at least in part to serve as a visual cue during escape in darkness or smoke.

A latch 68 is located on the inward-facing surface 72 of the door 66. The latch 68 operatively couples the door 66 to the second enclosure portion 64. As shown in FIG. 3, and as will be appreciated more clearly from FIG. 4, the latch 68 is shown in a bolt-engaging relationship to the second enclosure portion 64. In this way, the latch 68 is operable to secure the door 66 closed. The latch 68 is also operable from proximate the inward-facing surface 72 of the door 66 to release the door 66 so that the door 66 may be moved to an open position. As shown, the latch 68 is of the push-bar-to-exit variety that may be found on fire doors or other panic exits and is of outdoor grade (Global Door Controls, Inc., Charlotte, N.C.). The panic bar is covered with red or a reflective coating.

A guard 70 projects inwardly (i.e., toward the area being enclosed) proximate the latch 68. As shown, the guard 70 is formed by firmly attaching a rigid plate (in one embodiment approximately 12 centimeters long, 10 centimeters high and 0.4 centimeters thick) to the second enclosure portion 64. Where the second enclosure portion 64 is a steel post, a steel plate is welded or bolted to it. Other means of forming or attaching the guard 70 may be substituted, such as, for example, forming it integrally with the second enclosure portion 64, fitting it to a groove or slot formed in the second enclosure portion 64, or the like. The dimensions of the guard 70 are variable and may, for example, be increased so that the guard 70 projects 20 or more centimeters inward and extends farther above and below the latch 68. The material is also variable. Preferably, the guard 70 is formed of solid steel. To defeat intruders, a thickness in the range of about ¼″ to ⅛″ is desirable. Alternatively, the guard 70 is formed of spring steel, a tight, tough mesh or screen, tempered glass, or the like. Preferably, the latch 68 is finished to be highly contrasting, easily recognized and reflective to facilitate its recognition in darkness or smoke.

The guard 70 functions to defeat the type of tampering that has enabled many intruders in the past to enter an oil well work site. Even though a person might be able insert a finger, a small hand or forearm, or a tool such as a pair of pliers or a screwdriver into the enclosed area—perhaps between the wires of a cyclone fence or through a gap between the second enclosure portion 64 (fence post) and an edge of a segment of fence—such a person will have difficulty bypassing the guard 70 while maintaining enough leverage and control to operate the latch 68.

In a panic exit-only gate like those found at oil pump work sites, the exit in accordance with the present invention allows the latch 68 to be operated quickly and the door 66 to be forced open outwardly in an emergency, while it protects the latch 68 from unwanted manipulation by persons located outside the gate. Additionally, the guard 70 projects from the usually immobile second enclosure portion 64 and not from the door 66. Contrastingly, a guard 70 projecting from a door 66 would move with the door 66 as the door 66 swings open and would protrude into the path of persons using the door 66 to exit. In an emergency, such a guard 70 could snag the clothing or equipment of a person who may be rushing out through the exit to escape fire or dangerous vapors, possibly injuring that person and possibly also causing the gate to backlash into the path of another person.

With continued reference to FIG. 3, in an exemplary embodiment of an exit in accordance with the present invention, an additional penetration-defeating barrier 74 is optionally disposed on the door 66 proximate the latch 68. As illustrated, the barrier 74 extends the width of the door 66 and approximately 15 centimeters above and below the level of the illustrated push-bar-to-exit latch 68. The barrier is useful to reinforce the covered area of the door 66 against forcible penetration.

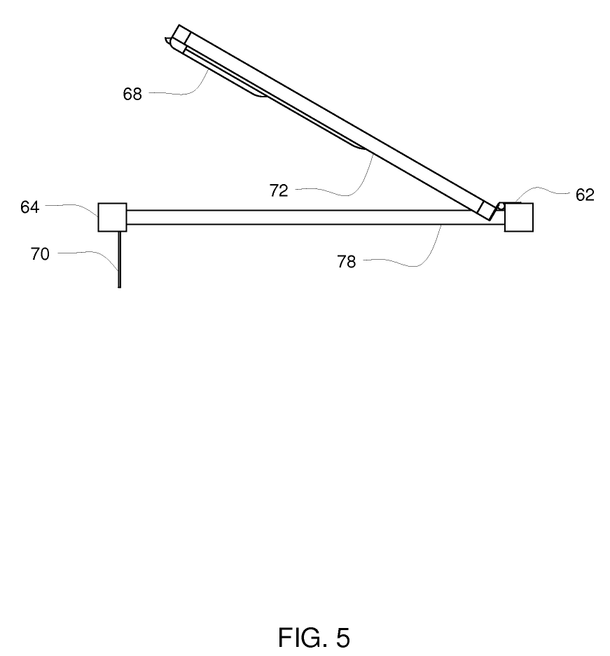

With continued reference to FIG. 3 and now also to FIG. 6, an inside perspective view of an exemplary embodiment of an exit in accordance with the present invention, a welded rectangular steel upper cross-member 76, at least one row of barbwire 77, and lower cross-member 78 join the first enclosure portion 62 to the second enclosure portion 64. The lower cross-member 78 is intended to be buried in the ground during installation. In one embodiment, the cross-members are 2″ by 2″ square galvanized tubing welded to the enclosure portions. Other materials, shapes and methods of joining may be substituted. For example, aluminum tubing, wood, I-beams, reinforcement bars, polymeric and composite extrusions, or the like, may be welded, bolted, wired, tied, interference-fitted, glued, or otherwise fused to form the illustrated structure.

When joined together in this manner, the gate is deliverable as a complete module and installable without any need for assembly at the place of installation. Advantageously, any skill and care needed to properly assemble and fasten the exit may be procured efficiently at a factory, rather than being deployed at great expense at the place of installation.

With continued reference to FIG. 6, in another exemplary embodiment of an exit in accordance with the present invention, a tubular steel first anchor 80 is welded to the first enclosure portion 62 and a tubular steel second anchor 82 is attached to the second enclosure portion 64. The first anchor 80 and the second anchor 82 are located at a level below the lower cross-member 78, so that cross-member 78 and the anchors may be buried or, preferably, set in concrete which is poured at the time of installation. They extend roughly horizontally and are oriented so as not to interfere with other portions of the gate or fence, which may also be underground. Besides tubular steel, other weather-resistant materials and shapes, such as solid bars, can be used

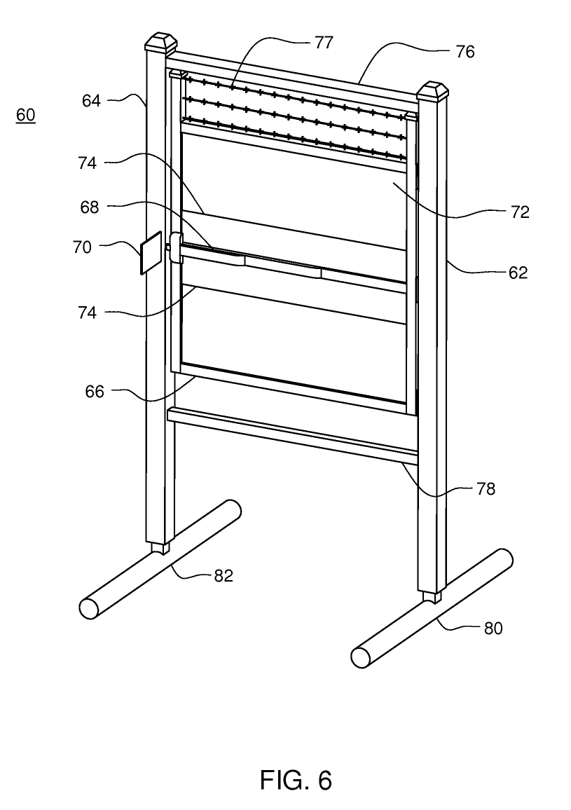

FIG. 7 is a top view of another exemplary embodiment of an exit in accordance with the present invention, in which the guard 70 not only projects inwardly but also is angled toward the door 66, partially covering at least a portion of the latch 68 and at least a portion of the inward-facing surface of the door 66. FIG. 8 is a top view of another exemplary embodiment of a gate in accordance with the present invention, in which the guard 70 projects inwardly and also distally curves toward the door 66, partially covering at least a portion of the latch 68 and at least a portion of the inward-facing surface of the door 66. These angled and curved embodiments further obstruct any tool being used to disengage the latch 68 from the second enclosure portion 64, thereby further frustrating an intruder. It is noted that these embodiments are suited primarily for a door 66 which opens outwardly only, such that a guard 70 which is angled or curved toward the door 66 would not interfere with the operation of the door 66.

As shown in FIGS. 3-8, the exemplary embodiments of the exit use a push-bar-to-exit type of latch 68—which is preferable when escaping from a ruptured oil well, a fire, an impending explosion, or the like, because one need not exercise precision or control in order to open the door 66. However, because so little precision or control is required to open the door 66, such an arrangement is vulnerable to unwanted manipulation by intruders who insert a body part or tool into the fence or gate from the outside in an attempt to unlatch the easily-opened door 66. Advantageously, the guard 70 compensates for this vulnerability by forcing any inserted body part or tool to follow an inconveniently indirect path to reach any part of the latch 68.

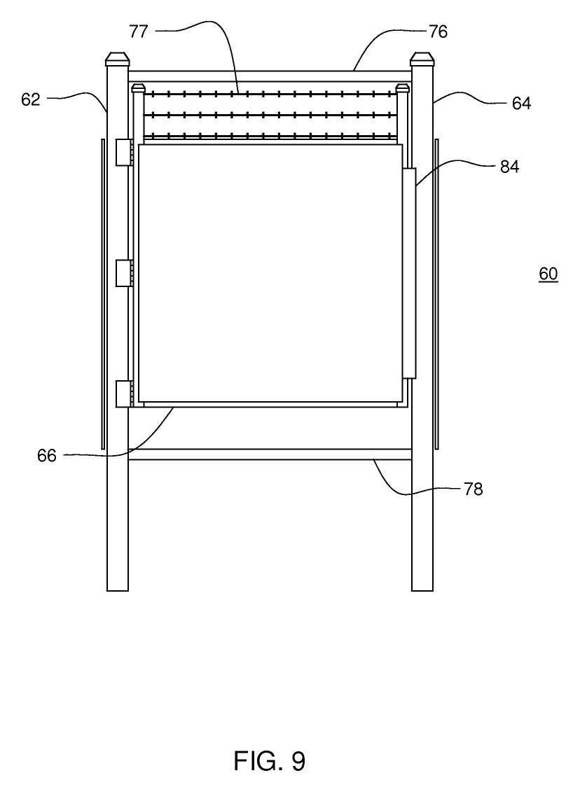

FIG. 9 is an outside elevational view of an exit in accordance with the present invention showing the first enclosure portion 62, the second enclosure portion 64, and the door 66, which is hinged to the first enclosure portion 62. A long, narrow, rigid strip 84 is shown affixed to the second enclosure portion 64 to reduce the tolerance between the second enclosure portion 64 and the door 66 in order to resist tampering. In one embodiment, this strip is 1.5″ wide and about ⅛″ thick galvanized strap metal.

With continued reference to FIGS. 3-8, an exemplary embodiment of an exit closure in accordance with the present invention is useful for securing a door 66 relative to an adjacent enclosure portion. This exemplary exit closure comprises a latch 68 installed to operatively couple the door 66 to the enclosure portion 64. The latch 68 is operable to secure the door 66 closed relative to the enclosure portion 64 and is also operable from proximate the inward-facing surface 72 of the door 66 to release the door 66 to open relative to the enclosure portion 64. A guard 70 is attached to the enclosure portion 64 and projects from the inward-facing surface of the enclosure portion 64 proximate the latch 68. This exemplary embodiment of an exit closure is a valuable addition to, or replacement for, the latch 68 that might commonly be used on a previously installed panic exit-only gate.

Also with continued reference to FIGS. 3-8, an exemplary embodiment of an exit closure guard 70 in accordance with the present invention is useful for enhancing the intrusion resistance of a door 66 which is secured closed relative to an adjacent enclosure portion by a latch 68 of the type previously discussed, namely, one operable to secure the door 66 closed relative to the enclosure portion and is also operable from proximate the inward-facing surface 72 of the door 66 to release the door 66 to open relative to the enclosure portion. In accordance with the present invention, an exit closure guard 70 comprises a guard 70 attached to the enclosure portion and projecting from the inward-facing surface of the enclosure portion proximate the latch 68. This exemplary embodiment of an exit closure guard 70 is a valuable addition to a previously installed panic exit-only gate already equipped with a push-bar-to-exit latch 68. As shown in FIGS. 7 and 8 and described above, the guard 70 is variable in dimensions, shape, material and means of attachment.

Also with continued reference to FIGS. 3-8, an exemplary method of gating a fence in accordance with the present invention includes the steps of integrating spaced-apart first and second enclosure portions 62 and 64 with the fence or wall; disposing a door 66 between the enclosure portions 62 and 64, the door 66 being movable between a closed position and an open position relative to the enclosure portions 62 and 64, the door 66 and the enclosure portions having inward-facing surfaces; providing a latch 68 operatively coupling the door 66 to one of the enclosure portions 64, the latch 68 being operable to secure the door 66 in the closed position, the latch 68 being operable from proximate the inward-facing surface 72 to release the door 66 to be moved to the open position; and affixing a guard 70 to one of the enclosure portions, the guard 70 projecting inwardly proximate the latch 68.

Optionally in accordance with this exemplary method, the enclosure portions 62 and 64 may be joined together before they are integrated with the fence. This is accomplished by welding an upper cross-member 76 and a lower cross-member 78 between the first enclosure portion 62 and the second enclosure portion 64. Thus, the door 66 is closely and safely approximated to the first enclosure portion 62 and the second enclosure portion 64 before installation of the gate on site.

Also with continued reference to FIGS. 3-8, an exemplary method of gating an fence in accordance with the present invention comprises the additional steps of joining at least one anchor 80 to at least one of the enclosure portions and burying the anchor 80 or setting it in concrete during installation. This is preferably accomplished by welding a tubular steel first anchor 80 to the first enclosure portion 62 and a tubular steel second anchor 82 to the second enclosure portion 64. In this way, the first enclosure portion 62 and the second enclosure portion 64 are ready to be immobilized in the ground as soon as the hole(s) is dug. In one embodiment, 2 anchors are affixed (as by welding) to the enclosure portions 62 and 64 and are 2″ to 3″ galvanized steel pipe.

Also with continued reference to FIGS. 3-8, in another exemplary method of gating a fence or wall in accordance with the present invention, the steps of joining the first enclosure portion 62 to the second enclosure portion 64 together and joining the anchors 80 and 82 to them are performed before the step of integrating them with the gate, after which the assembled parts are ready to be placed in the ground as a unit and immobilized with concrete.

Also with continued reference to FIGS. 3-8, in another exemplary method of gating a fence in accordance with the present invention, the steps of disposing the door 66 between the first enclosure portion 62 and the second enclosure portion 64, providing the latch 68, and affixing the guard 70 to the second enclosure portion 64 all are performed before the step of integrating the enclosure portions with the fence, and then, before the step of integrating the enclosure portions with the fence, further steps are included for joining an upper cross-member 76 to the enclosure portions above the door 66, joining a lower cross-member 78 to the enclosure portions below the door 66, and joining at least one anchor 80 or 82 to at least one of the first enclosure portion 62, and/or the second enclosure portion 64.

Advantageously, this exemplary method of gating a fence allows two very important operational changes. First, the skill and equipment for precisely approximating the first enclosure portion 62, second enclosure portion 64, upper cross-member 76, lower-cross-member, anchor(s) 80 and/or 82, door 66, latch 68, and guard 70 and appropriately joining them are procured efficiently at a factory location, lowering costs and improving quality and working conditions. Second, such activities as cutting, welding, and de-burring no longer need to be performed at the work site. These activities all produce flame or sparks, which are dangerous in the presence of flammable vapors or liquids or in near dry brush or grassland—precisely the conditions found in an oil field. Because the method in accordance with the present invention gates the work area without requiring any of those activities, it can be conducted without seeking a hot-work permit and possibly also without ceasing flammable vapor-producing operations at the site of installation. Thus, gating the work area in accordance with the present invention upgrades the security and safety of the work site while avoiding opportunity costs and regulatory compliance costs of doing so with previously existing technology and practices.

As can be seen from the drawing figures and from the description, each embodiment of the exit, exit gate closure, exit gate closure guard 70, and method of gating a fence in accordance with the present invention solves a problem by addressing the need for improved intrusion resistance and streamlined, fire-safe installation, especially around flammable materials.

Although specific embodiments have been illustrated and described herein, those of ordinary skill in the art will appreciate that any arrangement calculated to achieve same purposes can be substituted for the specific embodiments shown. This disclosure is intended to cover any and all adaptations or variations of various embodiments of the invention. It is to be understood that the above description has been made in an illustrative fashion, and not a restrictive one. Combinations of the above embodiments, and other embodiments not specifically described herein will be apparent to those of skill in the art upon reviewing the above description. The scope of various embodiments of the invention includes any other applications in which the above structures and methods are used. Therefore, the scope of various embodiments of the invention should be determined with reference to the appended claims, along with the full range of equivalents to which such claims are entitled.

In the foregoing description, if various features are grouped together in a single embodiment for the purpose of streamlining the disclosure, this method of disclosure is not to be interpreted as reflecting an intention that the claimed embodiments of the invention require more features than are expressly recited in each claim. Rather, as the following claims reflect, inventive subject matter lies in less than all features of a single disclosed embodiment. Thus the following claims, and such other claims as may later be added, are hereby incorporated into the description of the embodiments of the invention, with each claim standing on its own as a separate preferred embodiment.

We claim:

1. An exit, comprising:
spaced apart first and second enclosure portions;
a door disposed between said enclosure portions, said door being movable between a closed position and an open position relative to said enclosure portions, said door and said enclosure portions having inward-facing surfaces;
a latch operatively coupling said door to at least one of said enclosure portions, said latch being operable to secure said door in said closed position, said latch being operable from proximate said inward-facing surface to release said door to be moved to said open position; and
a guard attached to one of said enclosure portions and projecting inwardly proximate said latch.

2. An exit as set forth in claim 1, wherein a penetration-defeating barrier is disposed on said door proximate said latch.

3. An exit as set forth in claim 1, wherein said enclosure portions are joined together, thereby permitting the door with said enclosure portions to be delivered to a site pre-hung.

4. An exit as set forth in claim 1, comprising at least one anchor attached to at least one of said enclosure portions, thereby the anchor immobilizes the enclosure portions when the anchor is buried or set in concrete.

5. An exit as set forth in claim 4, wherein at least one of said enclosure portions comprises a post.

6. An exit as set forth in claim 3, comprising an anchor attached to at least one of said enclosure portions.

7. An exit as set forth in claim 6, wherein at least one of said enclosure portions comprises a post.

8. An exit as set forth in claim 1, wherein said door is movable, outward-only, to said open position.

9. An exit as set forth in claim 8, wherein said guard projects toward said door and partially covers said latch proximate said inward-facing surface of said door.

10. An exit as set forth in claim 8, wherein said guard curves distally toward said door and partially covers said latch proximate said inward-facing surface of said door.

11. An exit as set forth in claim 1, wherein said latch comprises a push-bar opening mechanism.

12. An exit as set forth in claim 11, wherein said guard projects toward said door and partially covers said latch proximate said inward-facing surface of said door.

13. An exit as set forth in claim 11, wherein said guard curves distally toward said door and partially covers said latch proximate said inward-facing surface of said door.

14. An exit closure for securing a mostly solid door, where the door has an inward-facing surface and an opposite, outward-facing surface, relative to an adjacent enclosure portion, and where the enclosure portion also has an inward-facing surface and an opposite, outward-facing surface, the claimed exit closure comprising:
a latch operatively coupling said door to enclosure portion, said latch being operable to secure said door closed relative to said enclosure portion, said latch being operable from proximate said inward-facing surface of said door to release said door to open relative to said enclosure portion; and
a guard projecting from said inward-facing surface of said enclosure portion proximate said latch.

15. An exit closure guard, for thwarting circumvention of a latch closing an exit door relative to an enclosure portion, where the door has an inward-facing surface and an opposite, outward-facing surface, relative to an adjacent enclosure portion, and where the enclosure portion also has an inward-facing surface and an opposite, outward-facing surface, the claimed exit closure guard comprising:
a guard projecting from said inward-facing surface of said enclosure portion proximate said latch.

16. A method of gating a fence, comprising the steps of:
integrating spaced-apart first and second enclosure portions with the fence;
disposing a mostly solid door between said enclosure portions, said door being movable between a closed position and an open position relative to said enclosure portions, said door and said enclosure portions having inward-facing surfaces;
providing a latch operatively coupling said door to at least one of said enclosure portions, said latch being operable to secure said door in said closed position, said latch being operable from proximate said inward-facing surface to release said door to be moved to said open position; and
affixing a guard to one of said enclosure portions, said guard projecting inwardly proximate said latch.

17. A method of gating a fence as set forth in claim 16, comprising the step of joining said enclosure portions together before integrating them with the fence.

18. A method of gating a fence as set forth in claim 16, comprising the step of joining at least one anchor to at least one of said enclosure portions.

19. A method of gating a fence as set forth in claim 18, further comprising the step of joining said enclosure portions.

20. A method of gating a fence comprising
providing an exit comprising: spaced-apart first and second enclosure portions joined by an upper cross-member and a lower cross-member and at least one anchor joined to at least one of said enclosure portions; a mostly solid door disposed between said enclosure portions, said door being movable between a closed position and an open position relative to said enclosure portions, said door and said enclosure portions having inward-facing surfaces; a latch operatively coupling said door to one of said enclosure portions, said latch being operable to secure said door in said closed position, said latch being operable from said inward-facing surface to release said door to be moved to said open position; and a guard attached to one of said enclosure portions and projecting inwardly proximate said latch;
digging holes for the enclosure portions and at least one anchor sufficiently deep to permit the lower cross-member to sit in the ground;
placing the exit;
pouring concrete up to about the ground surface; and
attaching the fence to the enclosure portions.
